(19) United States
(12) Patent Application Publication
(10) Pub. No.: US 2007/0065089 A1
(43) Pub. Date: Mar. 22, 2007

(54) Optical termination apparatus and optical transmission system

(76) Inventors: Tadashi Matsuoka, Yokohama (JP); Shinji Sakano, Kamakura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/503,995

(22) Filed: Aug. 15, 2006

(30) Foreign Application Priority Data
Aug. 19, 2005 (JP) 2005-238318

(51) Int. Cl. G02B 6/00

(52) U.S. Cl. 385/140; 385/24

(57) ABSTRACT

A Triple-Player PON system is configured to have an optical line terminal (OLT) and an element management system (EMS), which are placed in a central office, an optical network terminal (ONT) placed in a subscriber's house, an optical splitter, a trunk line optical fiber, and a termination optical fiber. A variable optical attenuator is provided before a video optical receiver of the ONT, thereby to control the optical attenuation of the variable optical attenuator by a controller so that an input into the video optical receiver becomes an appropriate power.

### CLAIM OF PRIORITY

The present application claims priority from Japanese patent application serial no. 2005-238318, filed on Aug. 19, 2005, the content of which is hereby incorporated by reference into this application.

### BACKGROUND OF THE INVENTION

The present invention relates to an optical termination apparatus and optical transmission system, and more particularly to an optical network terminal and optical transmission system suitable for applying to a Triple-Play Passive Optical Network (Triple-Play PON) transmission system for transmitting voice, data and video through a single optical fiber.

In North America, there is a growing need for a Triple-Play service that can provide high-speed data communication, voice communication and video delivery through a single optical fiber, in order for telecommunications companies such as RBOCs (Regional Bell Operating Companies) and CLECs (Competitive Local Exchange Carriers) to compete with cable TV companies. A Triple-Play PON system is used as a means of providing the Triple-Play service at a low price.

The outline of the Triple-Play PON system will be described with reference to FIG. 1. Herein, FIG. 1 is a block diagram of a Triple-Play PON system. The Triple-Play PON system includes an optical line terminal (here after OLT) 10 on the central office side and plural optical network terminals (hereafter ONTs) 500. To the OLT 10 in a central office 100, a video head end 50 that is connected to a video network 200 to transmit a video signal wavelength, a router 20 connected to the Internet (IP network) 300 for data communication, and a voice gateway 30 and a Class 5 switch 40 connected to a public telephone network 400 for voice communication are connected respectively. To an ONT 500 in a subscriber's house 5, a television 530 for displaying a video signal, a personal computer 540 for performing data communication, and a telephone 520 for making voice communication are connected.

In the Triple-Play system PON, three different wavelengths are used, namely a wavelength for upstream data, a wavelength for downstream data and a wavelength for video. In order to use these wavelengths through an optical fiber, wavelength multiplexing is performed to provide optical transmission. In the Triple-Play PON system that is compliant with ITU-T standard, the wavelengths to be used are defined by Document 1 which is the standard for ITU-T. Document 1 defines the range of the downstream data wavelength as 1490 nm band, the range of the downstream video wavelength as 1550 nm band, and the range of the upstream data wavelength as 1310 nm band.

An important characteristic of Triple-Play PON is that it enables point-to-multipoint transmission ranging from 1 to N by branching in relation to the downstream data wavelength and the downstream video wavelength using an optical splitter 3. Lower cost of the system can be achieved by reducing the number of expensive apparatuses for transmitting the downstream wavelength as much as possible.

In the Triple-Play PON system, the optical attenuation in the used optical fiber and the used optical splitter varies greatly. Thus, a wide dynamic range is necessary on the data reception side. In the case of data input, a dynamic range of about 24 dB can be obtained and a particular adjustment is not necessary. However, the dynamic range on the reception side of the video signal used for the triple play is as narrow as about 5 dB, so that an optical attenuator is provided on the output side of the OLT 10 and/or on the reception side of the ONT to adjust the optical level on the video reception side to be within this range.

There are two ways to place the optical attenuator for the optical wavelength of the video signal: one is to place on the central office side; and the other is to place on the subscriber's side. In the case of placing the optical attenuator on the central office side, the optical attenuator has been placed between a video headend 50 and the OLT 10. In the case of placing the optical attenuator on the subscriber's side, the optical attenuator has been placed between the splitter 3 and the ONT 500.

Document 1: ITU, “A broadband optical access system with increased service capability by wavelength allocation”, ITU-T G.983.3

In the Triple-Play PON system, the cost of the entire system is suppressed by branching one signal into plural signals by the optical splitter. When the optical attenuator is inserted into the base station side, all the apparatuses on the end office side after the branching in the optical splitter need to have a certain amount of loss. For example, when each of the ONTs does not have an equal loss, there is a possibility that although an appropriate optical power would be input in some of the ONTs, the input power could be insufficient or too high in the other ONTs because the dynamic range on the reception side of the video signal is very narrow, as described above.

To avoid this problem the optical attenuator is used at the entrance of the ONT, which causes a loss to all the wavelengths (video optical wavelength, upstream optical wavelength, and downstream optical wavelength). The signal level of the wavelength of the downstream video optical signal is reduced to the range where video can be received by the optical attenuator. At this time, the signal level of the wavelength output of the upstream data signal would also be reduced, and the signal level is likely to be less than the minimum receiver sensitivity of the data input in the OLT 10. The loss in the optical fiber at a wavelength of 1310 nm band used for the upstream data wavelength is greater than at a downstream wavelengths of 1490 nm band and 1550 nm band, so that the signal level is likely to be less than the minimum receiver sensitivity.

The optical attenuator is used at the entrance of the ONT 500, and an optical output of 20 dBm is output from the video headend 50. When losses are incurred in a wavelength multiplexer/demultiplexer 12, a trunk line optical fiber 2, an optical splitter 3, a termination optical fiber 4 and an optical attenuator 6, the optical attenuator 6 at the entrance of the ONT 500 is adjusted to bring the optical power to the range of 0 dBm to −5.0 dBm where the video can be received. However, the upstream optical wavelength also passes through the same optical attenuator 6, so that the input power to a data signal transceiver 11 of the upstream optical wavelength is likely to be insufficient.

Further, the adjustment is done manually, requiring the time and personnel costs for installation. The loss value of the optical attenuator used for optical level adjustment is fixed by adjustment during installation, so that the video input power is likely to be out of the receivable range because of the change in the loss value of the fiber due to aged deterioration of the fiber or other factors.

There is another problem that in the case of transmitting plural wavelengths through a single fiber as the Triple-Play PON system, the wavelengths interfere with each other due to the nonlinear phenomenon of the optical fiber, causing signal deterioration. Particularly, when the wavelengths defined by Document 1 are used, the power of the data wavelength moves to the video wavelength due to Raman effect and an interference occurs, thereby causing deterioration of the video signal because the downstream data wavelength is at 1490 nm band and the downstream video wavelength is at 1550 nm band.

Further, since the power of the wavelength used for the video signal is high ranging from +18 dBm to +20 dBm, SBS (Stimulated Brillouin Scattering) that is caused by reflection within the fiber occurs when a higher power is input to the fiber, causing deterioration of the video signal. The higher power is necessary because losses are incurred not only by the fiber but also by the optical splitter at the same time, in the transmission of the video signal. It is also necessary to input a higher level with the minimum receiver sensitivity of −5 dBm on the reception side, because the video signal is an analog signal.

### SUMMARY OF THE INVENTION

According to the invention, an optimal video signal is input to all the ONTs that receives the signal without fail although the video signal is deteriorated by SRS (Stimulated Raman Scattering) or SBS.

The above problem can be solved by an ONT including a multiplexer/demultiplexer connected to an optical fiber to multiplex/demultiplex the upstream data signal and downstream data signal and downstream video signal, a variable optical attenuator provided between the multiplexer/demultiplexer and a video optical receiver to adjust a level of the downstream video signal, and a controller for monitoring an output of the video optical receiver to adjust the variable optical attenuator.

### BRIEF DESCRIPTION OF THE DRAWINGS

Preferred embodiments of the present invention will now be described in conjunction with the accompanying drawings, in which:

FIG. 1 is a block diagram of a Triple-Play PON system;

FIG. 2 is a block diagram of a Triple-Play PON system;

FIG. 3 is a control flowchart of an optical network terminal (ONT);

FIG. 4 is a block diagram of an ONT; and

FIG. 5 is a control flowchart of an ONT.

### DESCRIPTION OF THE PREFERRED EMBODIMENTS

The embodiments of the present invention will be described hereinafter, using examples with reference to the drawings. It is to be noted that the substantially same parts are denoted by the same reference numerals and the description thereof will not be repeated.

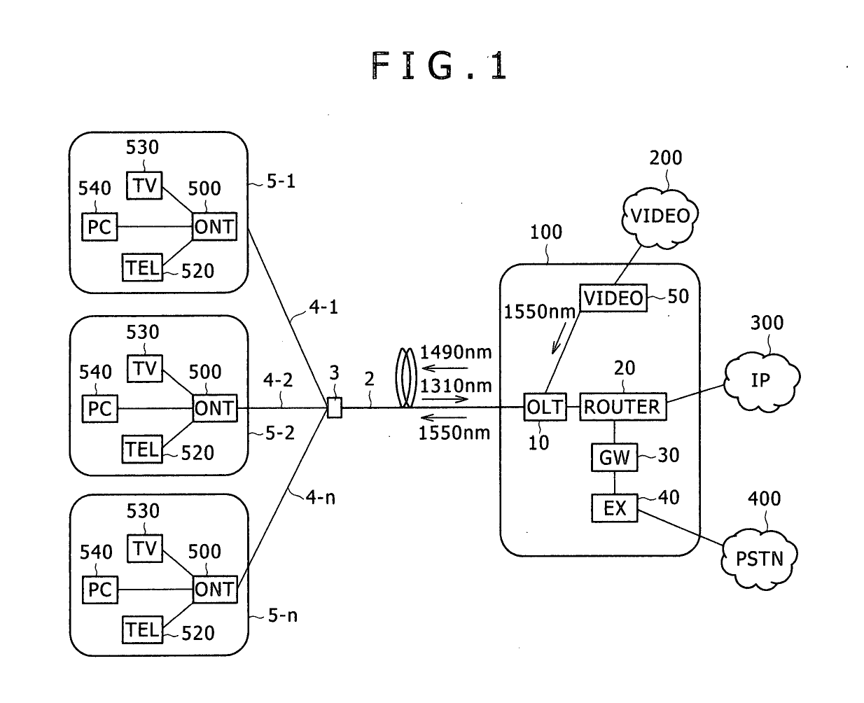

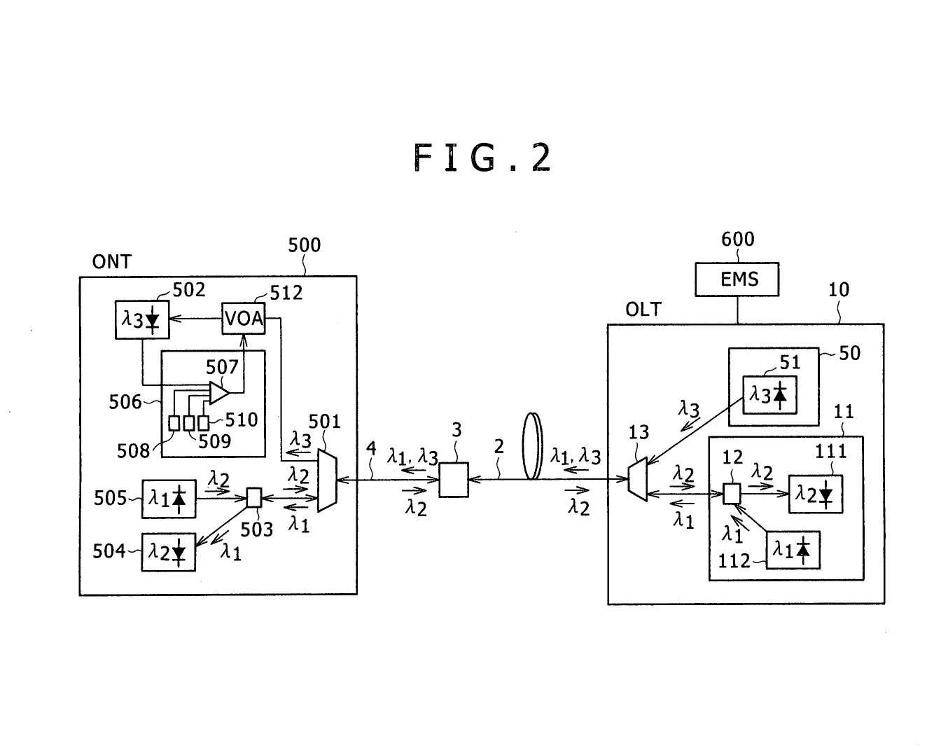

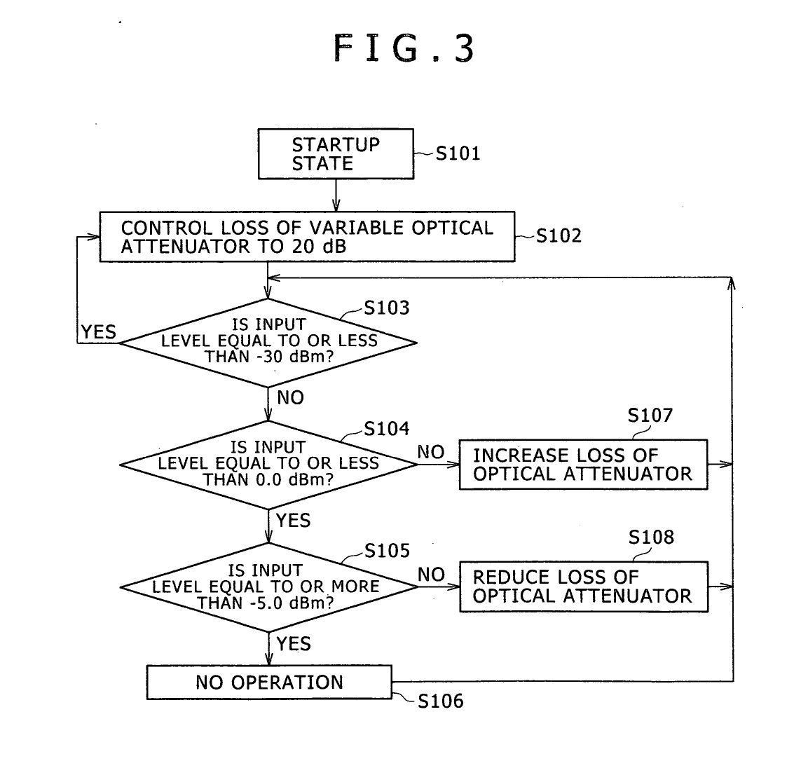

Embodiment 1 will be described with reference to FIGS. 2 and 3. Herein, FIG. 2 is a block diagram of a Triple-Play PON system. FIG. 3 is a control flowchart of an ONT. Incidentally, in FIG. 2 and the following figures, a video head end of FIG. 1 is referred to as a video signal transmitter. For illustrative convenience, the video signal transmitter is shown as being provided within the OLT 10. Also, only one subscriber's house is described in the figures.

In FIG. 2, the Triple-Play PON system includes an OLT 10 and an EMS (Element Management System) 600 that are placed in a central office, an ONT 500 placed in a subscriber's house, an optical splitter 3, a trunk line optical fiber 2, and a termination optical fiber 4. Herein, the EMS 600 is a monitoring device for the Triple-Play PON system. A data signal transceiver 11 of the OLT 10 is connected to a router 20 of FIG. 1. A video signal transmitter 50 of the OLT 10 is connected to a video network 200 of FIG. 1. Further, a video optical receiver 502 of the ONT 500 is connected to a television 530 of FIG. 1. A data optical receiver 504 and data optical transmitter 505 of the ONT 500 are connected to a personal computer 540 and telephone 520 of FIG. 1.

A first wavelength λ1 transmitted from a data optical transmitter 112 of the data signal transceiver 11 of the OLT 10 is multiplexed and demultiplexed with second wavelength λ2 coming from the ONT 500, by a first wavelength multiplexer/demultiplexer 12. The second wavelength λ2 coming from the end office side is demultiplexed by the first wavelength multiplexer/demultiplexer 12, and is received by a data optical receiver 111.

The first wavelength λ1 multiplexed in the first wavelength multiplexer/demultiplexer 12 is multiplexed with third wavelength λ3 transmitted from a video optical transmitter 51 of the video optical transmitter 50 of the OLT 10, and is transmitted to the trunk line optical fiber 2. While, the second wavelength λ2 coming from the ONT 500 is demultiplexed by a second wavelength multiplexer/demultiplexer 13, and is transmitted to the first wavelength multiplexer/demultiplexer 12.

The first wavelength λ1 and third wavelength λ3 transmitted from the OLT 10 are branched by the optical splitter 3 after transmission through the trunk line optical fiber 2, and the wavelengths are transmitted to each of the optical fibers 4 for end office. The optical splitter 3 aggregates all the second wavelengths λ2 transmitted from plural the ONTs 500, and transmits to the OLT 10.

The first wavelength λ1 and third wavelength λ3 transmitted to the optical fiber 4 for end office from the optical splitter 3 are transmitted to the ONT 500. Then the wavelengths are demultiplexed by a third wavelength multiplexer/demultiplexer 501 of the ONT 500. The demultiplexed first wavelength λ1 is multiplexed with the second wavelength λ2 transmitted from the data optical transmitter 505 of the ONT 500, by a fourth wavelength multiplexer/demultiplexer 503. The multiplexed second wavelength λ2 is transmitted to the optical fibers for end office. The branched first wavelength λ1 is received by the data optical receiver 504.

The third wavelength λ3 demultiplexed by the third wavelength multiplexer/demultiplexer 501 is adjusted so that the optical level is within the receiving range of the video optical receiver 502, where the wavelength can be input, by a variable optical attenuator (VOA) 512. The third wavelength λ3 with the optical level adjusted is received by the video optical receiver 502.

The attenuation value of the variable optical attenuator 512 is controlled by a controller 506. A comparator 507 of the controller 506 compares the input power received in the video optical receiver 502 to a reference voltage. Based on the comparison result, the controller 506 controls the variable optical attenuator 512. FIG. 3 shows the flow of the control.

After startup of the ONT 500 (S101), the controller 506 sets the loss value of the variable optical attenuator 512 to 20 dB (S102). This is because the maximum power of the video optical signal transmitted from the OLT 10 is 20 dB, and because the optical power level to be input to the video optical receiver 502 is set to 0 dBm, which is the upper limit of the receivable range, even if the ONT 500 is directly connected by mistake. Next, the controller 506 compares the signal from the video optical receiver 502 to a reference voltage 508 equal to −30 dBm (S103). When the signal from the video optical receiver 502 is equal to or less than the reference voltage equal to −30 dBm, the controller 506 determines that no input light is present, thereby keeping the loss of the variable optical attenuator 512 at 20 dB (S102). When the input optical power is more than −30 dBm, the controller 506 determines that the input light is present, thereby comparing the input power to a reference voltage 509 equal to 0 dBm (S104). When the input power is more than 0 dBm, the controller 506 increases the loss of the variable optical attenuator 512 by 0.1 dB (S107), and then returns to Step 103. When the input power is equal to or less than 0 dBm in Step 104, the controller 506 compares it to a reference voltage 510 equal to −5 dBm (S105). When the input power is less than −5 dBm, the controller 506 reduces the loss of the variable optical attenuator 512 by 0.1 dB (S108), and then returns to Step 103. When the input power is equal to or more than −5 dBm in Step 105, the controller 506 does nothing as the input power is within the receivable range (S106), and then returns to Step 103. The processes from Step 103 to Step 108 are constantly operated during running of the ONT 500.

According to the embodiment, the received optical level of the video receiver with a narrow dynamic range is constantly monitored, so that it is possible to deal with changes in the input level due to such factors as input cut-off and deterioration of the fiber. As a result, reliability as the system increases. Further, the optical level is automatically adjusted, so that it is possible to reduce the startup time of the system. In addition, the optical power is dynamically controlled, so that it is possible to control the optical power to be optimal in the event of changes in the loss due to aged deterioration of the fiber or other factors.

Incidentally, the wavelength multiplexer/demultiplexer 501 and the wavelength multiplexer/demultiplexer 503 are serially connected in the ONT 500. However, it may be configured such that the wavelengths λ1, λ2, λ3 are respectively multiplexed and demultiplexed by the single wavelength multiplexer/demultiplexer 501. This is similar to the other embodiments.

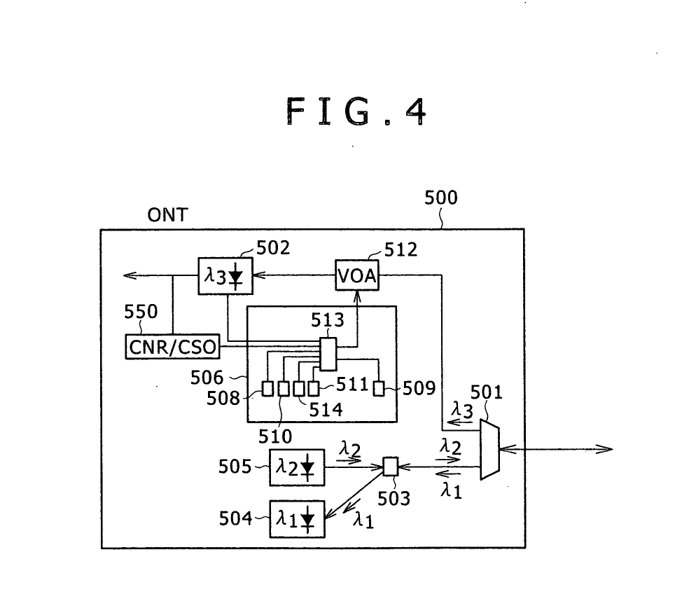

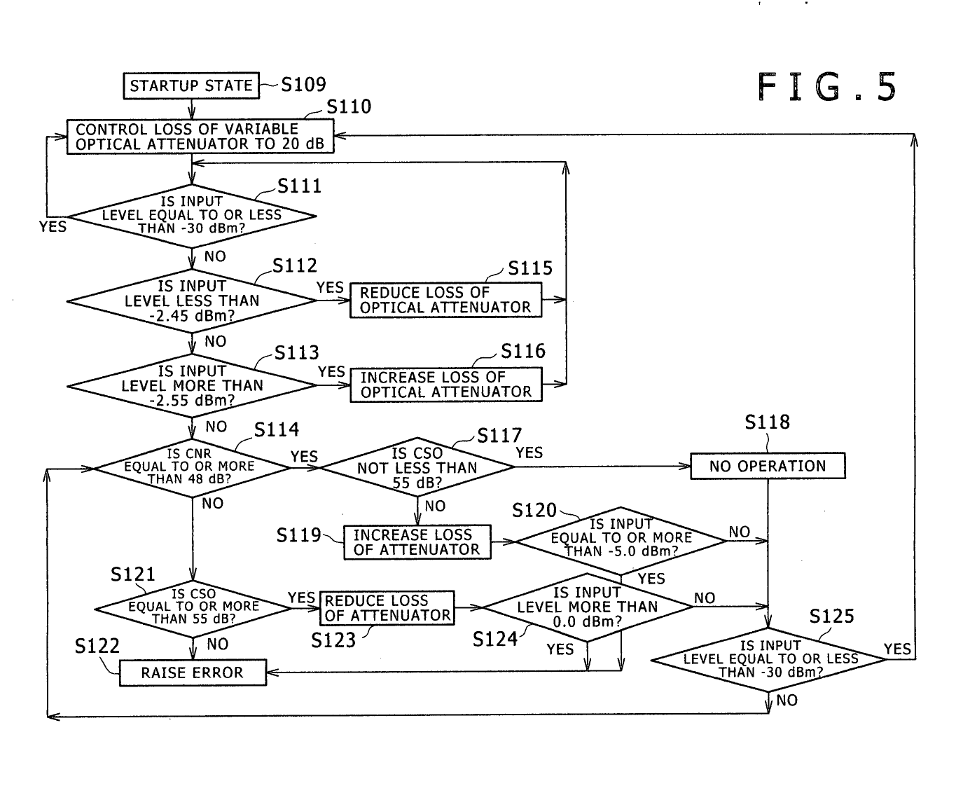

Embodiment 2 will be described with reference to FIGS. 4 and 5. Herein, FIG. 4 is a block diagram of an ONT. FIG. 5 is a control flowchart of the ONT. Incidentally, the ONT 500 of FIG. 4 has substantially the same configuration as the ONT 500 of the Triple-Play PON system described using FIG. 2, and the description on the same or similar components will be omitted. Also in the control flow of FIG. 5, the description on the flow parts described using FIG. 3 will be simplified.

The ONT 500 shown in FIG. 4 is different from the ONT 500 described in FIG. 2 with respect to the following points. That is, that the part using the comparator 507 in FIG. 2 is replaced with an operation instruction circuit 513, where a portion of the reference voltage is changed. Further a CNR/CSO computation circuit 550 is newly provided. Herein, the CNR/CSO computation circuit 550 is a circuit for calculating the CNR (Carrier to Noise Ratio) value and the CSO (Composite Second Order beat) value, from the video signal.

The attenuation value of the variable optical attenuator 512 is controlled by the controller 506. The operation instruction circuit 513 of the controller 506 instructs operations based on the signals received from the video optical receiver 502 and the CNR/CSO computation circuit 550. Based on the instruction, the controller 506 controls the variable optical attenuator 512. The control of the controller 506 will be described with reference to FIG. 5.

After startup of the ONT 500 (S109), the controller 506 controls the variable optical attenuator 512 so that the attenuation value is 20 dB (S110). Next, the controller 506 compares the received signal from the video optical receiver 502 to the reference voltage 508 equal to −30 dBm (S111). When the signal from the video optical receiver 502 is equal to or less than the reference voltage 508, the controller 506 determines that no input light is present, thereby keeping the loss of the variable optical attenuator 512 at 20 dB (S110).

When the input optical power is more than −30 dBm, the controller 506 determines that the input light is present, thereby comparing the input power to a reference voltage 511 equal to −2.45 dBm (S112). When the input optical power is less than −2.45 dBm, the controller 506 reduces the loss of the variable optical attenuator 512 by 0.05 dB (S115), and the process returns to the input level determination of −30 dBm in Step 111. When the input power is equal to or more than −2.45 dBm, the controller 506 compares it to a reference voltage 514 equal to −2.55 dBm (S113). When the input power is more than −2.55 dBm, the controller 506 increases the loss of the variable optical attenuator 512 by 0.05 dB (S116), and the process returns to the input level determination of −30 dBm in Step 111.

With the input power ranging from −2.45 to −2.55 dBm, the center of the dynamic range of 0 dBm to −5.0 dBm where input is accepted, and the process moves to the next determination. With the input level ranging from −2.45 to −2.55 dBm, the controller 506 determines whether the CNR value of the video signal is equal to or more than 48 dB (S114). When the CNR value is less than 48 dB, next the controller 506 determines whether the CSO value of the video signal is equal to or more than 55 dB (S121). When the CNR value is less than 48 dB and the CSO value is less than 55 dB, where relief is not possible, the controller 506 notifies the EMS 600 in FIG. 2 of an error (S122). When the CSO value is equal to or more than 55 dB in Step 121, where the CNR value can be improved by increasing the input power to the video optical receiver, the controller 506 reduces the loss of the variable optical attenuator 512 by 0.1 dB (S123). Subsequently, the controller 506 compares the input power to the reference voltage 509 equal to 0 dBm (S124). When the input power is more than 0 dBm, the controller 506 notifies an error because further correction is not possible (S122). When the input power is equal to or less than 0 dBm in Step 124, the controller 506 determines whether the input level is equal to or less than −30 dBm as the signal is cut off during the determination (S125). Herein, with the input level equal to or less than −30 dBm, the process returns to the control (S110) of setting the variable optical attenuator 512 to 20 dB. When the optical signal is more than −30 dBm, the process returns to the determination (S114) of whether the CNR value is equal to or more than 48 dB.

When the CNR value is equal to or more than 48 dB in Step 114, the controller 506 determines whether the CSO value of the video signal is equal to or more than 55 dB (S117). When the CNR value is equal to or more than 48 dB and the CSO value is equal to or more than 55 dB, where the video signal is optimized, the controller 506 does nothing (S118) and the process moves to the determination (S125) of the input level of −30 dBm (S125). The process returns to the determination (S114) of whether the CNR value is equal to or more than 48 dB, unless the input is cut off in Step 125.

When the CSO value is less than 55 dB in Step 117, where the CSO value can be improved by reducing the input power to the video optical receiver, the controller 506 increases the loss of the optical attenuator 502 by 0.1 dB (S119). Subsequently, the controller 506 compares the input power to the reference voltage 510 equal to −5 dBm (S120). When the input power is less than −5.0 dBm, the controller 506 notifies an error because further correction is not possible (S122). When the input power is equal to or more than −5.0 dBm in Step 120, the controller 506 determines whether the input level is equal to or less than −30 dBm as the signal is cut off during the determination (S125). With the input power equal to or less than −30 dBm, the process returns to the control (S110) of setting the variable optical attenuator 502 to 20 dB. With the optical signal more than −30 dBm in Step 125, the process returns to the determination (S114) of whether the CNR value is equal to or more than 48 dB.

According to the embodiment, the received optical level of the video receiver with a narrow dynamic range is constantly monitored, so that it is possible to deal with changes in the input level due to deterioration of the fiber or other factors. As a result, reliability as the system is improved. Further, the optical level is automatically adjusted, so that it is possible to reduce the startup time of the system. In addition, the optical power is dynamically controlled, so that it is possible to control the optical power to be optimal in the event of changes in the loss due to aged deterioration of the fiber or other factors.

Further, according to the embodiment, deterioration of the video signal can be corrected. It is designed to improve CNR when CNR of the video signal deteriorates, by increasing the optical power input to the video receiver. Similarly, it is designed to improve CSO when CSO of the video signal deteriorates, by reducing the optical power input to the video receiver. The optical attenuator is automatically controlled so as to provide the optimal optical power depending on the state of the video signal. Thus, reliability as the system can be improved.

Further, according to the embodiment, it is possible to reduce the signal deterioration due to the nonlinear effect of the fiber or other factors. It is designed to improve CNR when CNR of the video signal deteriorates due to the SRS effect, by adjusting to increase the optical power input to the video receiver. Similarly, it is designed to improve CSO when CSO of the video signal deteriorates due to the SBS effect, by adjusting to reduce the optical power input to the video receiver. The optical attenuator is controlled so as to provide the optimal optical power depending on the state of the signal. As a result, reliability as the system has been improved.

Even in the case where the loss between the OLT and each of the ONTs is not uniform, it is possible to optimize the input optical power to each of the receivers for the signal of the upstream data wavelength, the signal of the downstream data wavelength and the signal of the downstream video wavelength, respectively. This allows a more flexible placement of the transmission optical fiber.

The power of light is adjusted by the variable optical attenuator integrated into the end office side, so that the adjustment of the optical power can be performed automatically.

We claim:

1. An ONT including a data optical transmitter for transmitting an upstream data signal, a data optical receiver for receiving a downstream data signal, and a video optical receiver for receiving a downstream video signal, to transmit and receive said upstream data signal and said downstream data signal and said downstream video signal via a single optical fiber, said ONT comprising:
a multiplexer/demultiplexer connected to said optical fiber to multiplex/demultiplex said upstream data signal and said downstream data signal and said downstream video signal;
a variable optical attenuator provided between said multiplexer/demultiplexer and said video optical receiver to adjust a level of said downstream video signal; and
a controller for monitoring an output of said video optical receiver to adjust said variable optical attenuator.

2. An ONT including a data optical transmitter for transmitting an upstream data signal, a data optical receiver for receiving a downstream data signal, and a video optical receiver for receiving a downstream video signal, to transmit and receive said upstream data signal and said downstream data signal and said downstream video signal via a single optical fiber, said ONT comprising:
a multiplexer/demultiplexer connected to said optical fiber to multiplex/demultiplex said upstream data signal and said downstream data signal and said downstream video signal;
a variable optical attenuator provided between said multiplexer/demultiplexer and said video optical receiver to adjust a level of said downstream video signal;
a computation circuit for monitoring an output of said video optical receiver and calculating CNR (Carrier to Noise Ratio); and
a controller for monitoring the output of said video optical receiver to adjust said variable optical attenuator, further adjusting said variable optical attenuator based on the output of said computation circuit.

3. An ONT including a data optical transmitter for transmitting an upstream data signal, a data optical receiver for receiving a downstream data signal, and a video optical receiver for receiving a downstream video signal, to transmit and receive said upstream data signal and said downstream data signal and said downstream video signal via a single optical fiber, said ONT comprising:
a multiplexer/demultiplexer connected to said optical fiber to multiplex/demultiplex said upstream data signal and said downstream data signal and said downstream video signal;
a variable optical attenuator provided between said multiplexer/demultiplexer and said video optical receiver to adjust a level of said downstream video signal;
a computation circuit for monitoring an output of said video optical receiver and calculating COS (Composite Second Order beat); and
a controller for monitoring the output of said video optical receiver to adjust said variable optical attenuator, further adjusting said variable optical attenuator based on the output of said computation circuit.

4. The ONT according to any of claims 1 to 3,
wherein an input level of said video optical receiver is adjusted in a range of −5.0 dBm to 0 dBm by said variable optical attenuator.

5. The ONT according to claim 4,
wherein the input level of said video optical receiver is adjusted in a range of −2.45 dBm to −2.55 dBm by said variable optical attenuator.

6. A transmission system for connecting an apparatus on a central office side provided in a central office building to an ONT provided in a subscriber's house via a first fiber that connects said OLT to a splitter and via a second fiber that connects said splitter to said ONT,
wherein said ONT includes a data optical transmitter for transmitting an upstream data signal, a data optical receiver for receiving a downstream data signal, and a video optical receiver for receiving a downstream video signal,
said ONT further including:
a multiplexer/demultiplexer connected to said second optical fiber to multiplex/demultiplex said upstream data signal and said downstream data signal and said downstream video signal;
a variable optical attenuator provided between said multiplexer/demultiplexer and said video optical receiver to adjust a level of said downstream video signal; and
a controller for monitoring an output of said video optical receiver to adjust said variable optical attenuator.
